(19) United States
(12) Patent Application Publication
(10) Pub. No.: US 2016/0193740 A1
(43) Pub. Date: Jul. 7, 2016

(54) Sure Grip Dual Head Shaving Razor

(71) Applicants: James Joseph Phillips, Bradenton, FL (US); Donald David Phillips, Twinsburg, OH (US)

(72) Inventors: James Joseph Phillips, Bradenton, FL (US); Donald David Phillips, Twinsburg, OH (US)

(21) Appl. No.: 14/961,841

(22) Filed: Dec. 7, 2015

Related U.S. Application Data
(60) Provisional application No. 62/123,975, filed on Dec. 5, 2014.

(51) Int. Cl. B26B 21/52; B26B 21/22

(52) U.S. Cl. CPC B26B 21/527; B26B 21/225; B26B 21/521

(57) ABSTRACT

A novel shaving razor handle, due to its finger rings retainer base that your index and middle fingers fit comfortably to the middle of the first knuckle and second knuckle leaving the finger tips to feel the skin, with replaceable shaving cartridges attached to opposite swiveling ends of the rotating connecting rod that passes through the finger retainer base, while fingers are retained, both shaving cartridges have 8 positions of shave 360 degrees rotation, turning right and left, unlocking the shaving position by pulling slightly the swiveling end out of its locking position, turning to the position of shave pushing hack to the locking position, making it possible for the medically needy to never fall to the ground, also the swiveling ends have an arc making it easy to shave the contour of your head bi-directionally in a pulling motion.

### CROSS REFERENCE TO RELATED APPLICATION

Not Applicable

### SEQUENCE LISTING OR PROGRAM

NOT APPLICABLE

### BACKGROUND OF THE INVENTION

1. Field of the Invention

This invention relates to a novel hair shaving razor handle, due to its two replaceable shaving cartridges located at the opposite ends of a rotating connecting rod, also this invention provides a novel method of holding the shaving razor with a two finger partial rings base for the index, and middle fingers to fit comfortably in a parallel partial rings base to the middle of the first knuckle and second knuckle, located in the center of a rotating connecting rod leaving the finger tips, when engaged to touch the skin for a close shave. Also this invention provides a novel and different method of shaving resulting from both shaving cartridges on either end of the rotating connecting rod to turn simultaneously 360 degrees and locking into 8 directions of shave by simply pulling slightly, the one swiveling end, which the shaving cartridge is attached out of its locking position and turning right or left, then releasing to the locking position enabling the other swiveling shaving cartridge, at the opposite end to turn simultaneously, while still retained to the fingers, which detours the dropping of the shaving apparatus. This novel partial rings retainer base handle will also be used in the medically needy who have neurological problems causing shaking of the hands, arthritis patients, and tremors. This novel method of shaving is a bi-directional shave by simply retaining fingers perpendicular in the finger partial rings retainer base, placing the dual shaving cartridges on the skin to be shaved, pulling one way with the one shaving cartridge, and pulling the other way with the opposite shaving cartridge.

2. Related Art

A dual headed razor GB112157974(A) Feb. 9, 2009. A double blade set shaving razor that is designed to shave the head but does not have finger retainers. While prior art in a stick shaving handles is hard to handle when wet and slippery tends to fall out of hand as in U.S. Pat. No. 7,131,202 Nov. 7,2006 Evan Pennell also U.S. Pat. No. 6,560,876 May 13, 2003 by Bryan Staley Carr, and U.S. Pat. No. 5,307,564 May 3, 1994 by Schoenberg. The Schonberg patent due to the handle, being long and uncontrollable not being able to reach the contour areas of the body, and does not have a dual finger ring retainer base. The dual head razors are found in U.S. Pat. No. 4,989,328 issued by Sokoloff, Feb, 5, 1991 is not a bi-directional razor as my novel invention, also Andrews U.S. Pat. No. 5,865,189 Feb. 2, 1999 is a bi headed shaving razor on an a stick handle which is used in a pushing and pulling the blades against the skin by moving the stick one way and another. None of the above is a finger ring retainer base that fits the contour of your index and middle fingers, and is a bi-directional dual replaceable razor cartridges that shaves in a pull shaving motion as my invention. Other known prior art includes U.S. Pat. No. 6,029,356, Feb. 29, 2006 by Brenda Sprinkle, has a finger pad sensor, but does not have dual shaving head cartridges allowing this invention to shave in a pull motion one way. Also the finger razor U.S. Pat. No. 5,357,680, Oct. 25, 1994 by Manistere a finger single razor comprising of a tapered sleeve, base plate retainer fitting onto the middle finger but not able to shave in a bi-directional manner. The rolling razor U.S. Pat. No. 6,493,950B1 Dec. 17, 2007 by Kludjian which does not have a two finger retainers base leaving free to fall to the ground, and does not have dual razor cartridges at either end of an elongated rod with index and middle, two finger ring retainer base in the middle that shaves the contour of your body

### SUMMARY OF THE INVENTION

Accordingly, it is an object of the invention to provide a novel way to provide innovative way of shaving.

It is yet another object of the invention to provide a novel method of shaving.

It Is yet another object of the invention to provide a novel way for two replaceable shaving cartridges.

It is yet another object of the invention to provide a novel way to have the replaceable shaving cartridges attached to the swiveling ends, which is connected on either end of a rotating connecting rod.

It is yet another object of the invention to provide a novel improved handle to have a finger partial rings retainer base for the index and middle fingers located in the middle of the rotating connecting rod.

It is yet another object of the invention to provide a novel way for the fingers to fit comfortably in the two tubular partial rings shaped finger retainer base to the middle of the first knuckle and the second knuckle, perpendicular to the rotating connecting rod.

It is yet another object of the invention to provide a novel way to have the rotating connecting rod pass parallel through the middle of the index and middle finger partial rings retainer base.

It is yet another object of the invention to provide a novel way for an arc to be at both ends approximately 45 degrees from the finger partial rings retainer base to the replaceable shaving cartridges, for an easy contoured shave.

It is yet another object of the invention to provide a novel way while the fingers are retained to the finger partial rings retainer base, for both replaceable shaving cartridges that is attached to the swiveling ends, that is connected to the rotating connecting rod ends, to turn simultaneously 360 degrees, 8 locking positions of shave.

It is yet another object of the invention to provide a novel way of both shaving cartridges at either end to turn 360 degrees simultaneously by pulling slightly the one end shaving cartridges, which is attached to the swiveling end, out of its locking position, from the rotating connecting rod and turning to the right, or left 1 or 8 positions of shave while still retained to the fingers.

It is yet another object of the invention to provide a novel shaving handle, along with the shaving cartridges to be the size to fit comfortably in the palm of your hand.

It is yet another object of the invention to provide a novel way when retained to the fingers and shaving the stubble off of the skin to be able to touch the skin with your finger tips as your shaving.

It is yet another object of the invention to provide a novel way to shave in a pulling motion, with the one end shaving cartridge, and pulling motion in the other direction with the other end shaving cartridge.

It is yet another object of the invention to provide a novel way for the medically handicapped such as arthritis or shaking of the limbs to not drop the shaving apparatus to the floor due to its finger partial rings retainer base.

### BRIEF DESCRIPTION OF THE SEVERAL VIEWS OF THE DRAWING

FIG. 1A is the top view of the two finger partial rings retainer base, showing the swiveling ends, and the shaving cartridges stainless steel blades placed on the skin.

FIG. 1B is the right side view of the finger partial rings retainer base, with the side view of the swiveling ends and the right side view of the shaving cartridges.

FIG. 1C is the one end view of the swiveling end, and the end view of the finger partial rings retainer base, with the end view of the shaving cartridge stainless steel blades.

FIG. 2A is the top view of the finger partial rings retainer base, with the side view of the swiveling ends and both shaving cartridges turned to the 90 degrees to the right.

FIG. 2B is the top view of the finger partial rings retainer base, with the view of the swiveling ends turned to the right 45 degrees, and the back of the replaceable shaving cartridge turned to right the 45 degrees.

FIG. 2C is the one end view of the finger partial rings retainer base, with the one side of the swiveling end turned to the right 90 degrees, being able to sec the shaving cartridge stainless steel blades also 90 degrees to the right.

FIG. 2D is the end view of two finger partial rings retainer base, with the view of the swiveling end with the shaving cartridges turned to the right 45 degrees position being able to see the stainless steel shaving blades.

FIG. 3A is the top view of the two finger rings retainer base, with the back view of the swiveling end, and the back views of the shaving cartridges, with the view of the shaving cartridge locking mechanism.

FIG. 3B is the separate view of FIG. 3A the top view of the swiveling end and the top view of the two finger partial rings retainer base, also the locking mechanism that shows the rotating connecting rod that allows both end shaving cartridges to turn simultaneously and lock into 8 or more position of shave

FIG. 3C is the separate view of FIG. 3D, showing the top view of the partial rings retainer base, and the top view of the swiveling end showing the locking mechanism holes and shaving cartridge.

FIG. 3D is the view of the depth, of the two finger rings retainer base end, with the top of the swiveling end and the shaving cartridge pulled out slightly to show the locking mechanism.

FIG. 3E is the bottom view of the two finger rings retainer base, with the bottom view of the swiveling end, the view of the shaving cartridge stainless steel blades with the view of the rotating connecting rod, and the swiveling end pulled out of the locking position showing the locking mechanism, opposite FIG. 3A

FIG. 4A is the back view of the two finger partial rings retainer base, with the view of the rotating connecting rod, the back view of the swiveling end, and the view of the cartridge stainless steel blades, with the one swiveling end pulled out to see the rotating connecting rod and showing the 8 locking positions of shave.

FIG. 4B is the side cut away view of the two finger rings retainer, showing the rotating connecting rod that connects both swiveling ends, with the one end pulled out of the locking mechanism making it possible for both ends to turn simultaneously 360 degrees.

FIG. 4C is the one end view of the two finger partial rings retainer base, with the one end of the swiveling end and the shaving cartridges stainless steel blades, showing the approx. 45 degree arc from the base to the shaving cartridge.

FIG. 4D is the separate cut away view of FIG. 4B, the one end of the two finger rings retainer, and the rotating connecting rod with the swivel end pulled out slightly of its locking mechanism, allowing both shaving cartridges to turn simultaneously 360 degrees, 8 positions of shave.

FIG. 5A is the top view of the two finger rings retainer base, showing the rotating swiveling ends simultaneously facing the same direction and the two replaceable shaving cartridges, one end cartridge disconnected from the rotating swiveling ends showing one of two connections with an approx. 45 degree arc from the finger retainer base to the shaving cartridge.

FIG. 5B is the top view of the two finger rings retainer base, with the rotating swiveling ends simultaneously facing the same direction and two replaceable shaving cartridges, one end shaving cartridge connected to the rotating swiveling end showing one of two connections with an approx. 45 degree arc from the two finger rings retainer base to the shaving cartridges.

FIG. 6A is the top view of the Sure Grip Dual Head Shaving Razor showing the finger partial rings retainer base, and the replaceable shaving cartridges connected to the rotating swiveling end.

FIG. 6B is the view of the index and middle fingers in the two finger partial rings retainer base with the top view of both swiveling ends and shaving cartridges in the position parallel to the area being shaved. Showing how the index and middle finger fit the finger partial rings base

### MODES FOR CARRYING OUT THE INVENTION

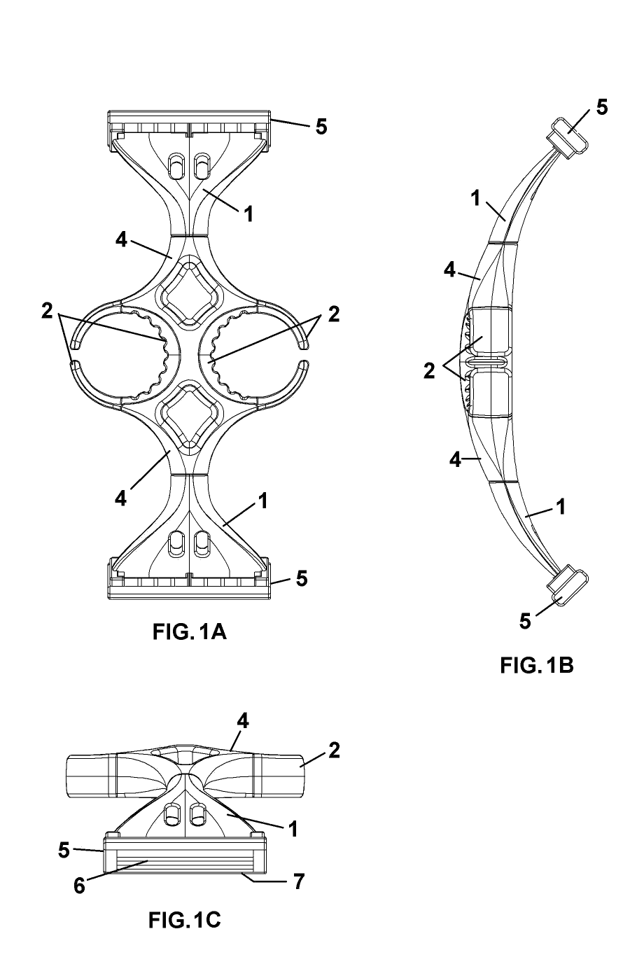

Referring to the drawings on the first page of six, FIG. 1A is the top view of the Sure Grip Dual Head Shaving Razor, a bi-directional shaving razor, due to its two replaceable shaving cartridges 5, connected to swiveling ends 1, on opposite sides of a two finger rings retainer base 4, which has two tubular shaped partial rings finger retainer 2 for the index and middle fingers.

Referring to FIG. 1B, illustrates the side view of the Sure Grip Dual Head Shaving Razor, the shaving cartridges at each end 5 that is connected to the swiveling ends 1, with the finger retainer base 4 also showing the thickness of the two finger retainer 2, for the index and middle fingers to fit comfortably due to the thermal plastic elastomer (TPE) which is a soft, and flexable.

Referring to FIG. 1C is the one end showing the replaceable shaving cartridge with at least three to four stainless steel shaving blades, attached to the swiveling end that is connected to a rotating connecting rod that is not seen in this figure but passes through the two finger rings retainer base 1 which is made with an injection mold with a more rigid plastic such as but not limited to polystyrene (PS), and a light weight metal of the sort.

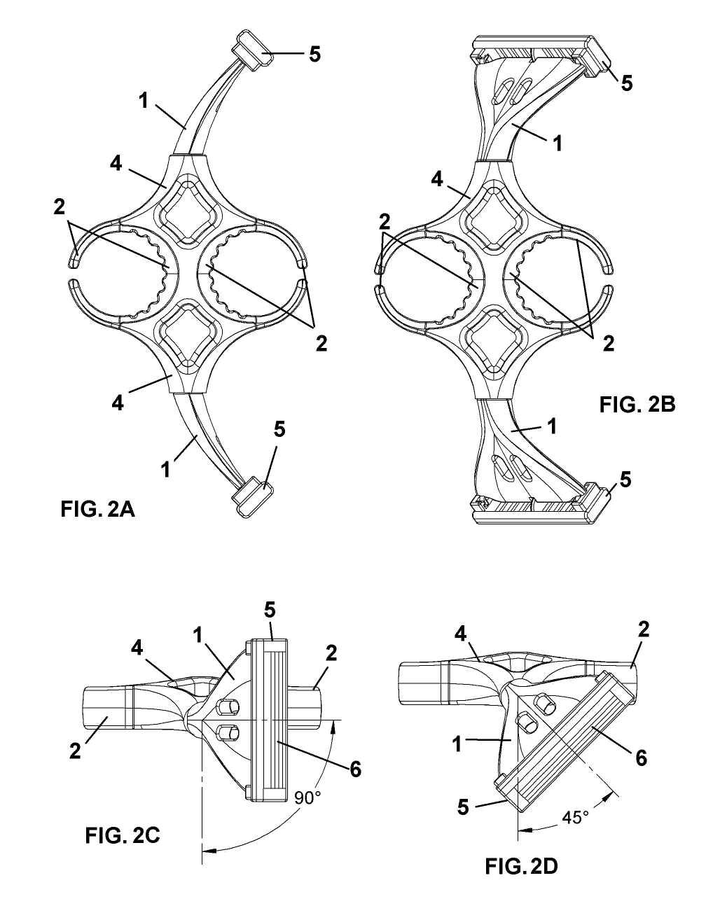

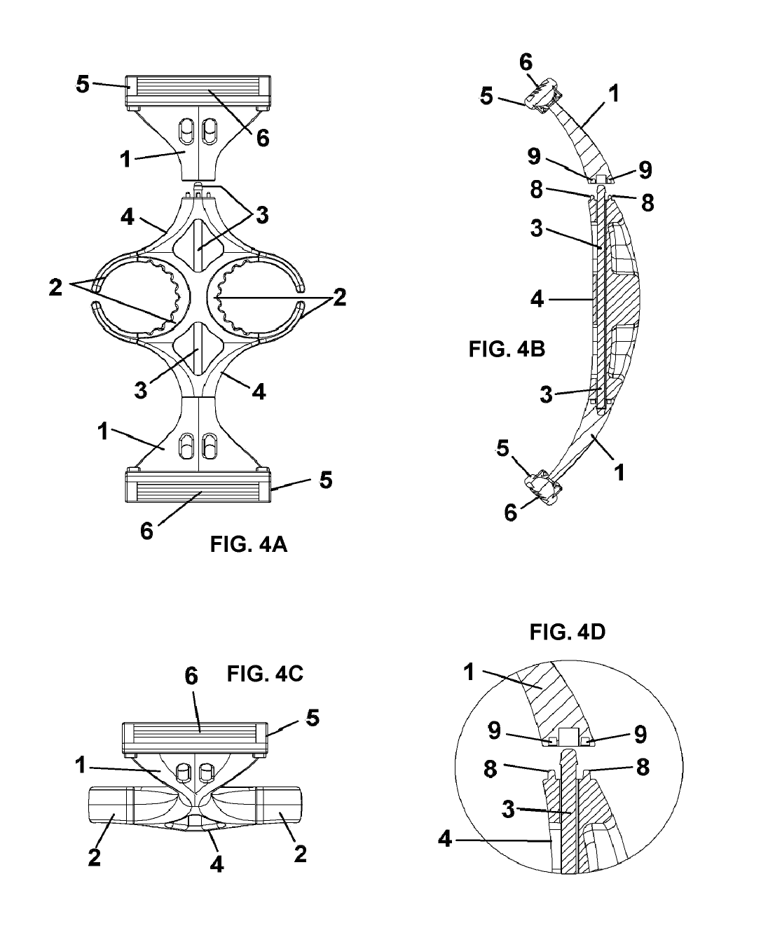

Referring to the second page of six of the illustrations, FIG. 2A shows the top view of the two finger rings retainer base 4 along with the index and middle finger softer plastic elastomer 2, showing the two swiveling ends 1, and the attached shaving cartridges 5 that are in the 90 degree position of shave that is due to the rotating connecting rod that is seen in FIG. 4A.

Referring to FIG. 2B illustrates the top view of the two finger rings retainer base 4 with the partial rings finger retainer 2, and the top view of the swiveling ends 1, and the back view of the shaving cartridge 5, turned to the right 45 degree position of shave.

Referring to FIG. 2C is the one end view of the replaceable shaving cartridge turned to the 90 degrees position 5, and the view of the stainless steel blades 6, connected to the top end view of the swiveling end 1, and the end view of the two finger rings retainer base 4, with an end view of the finger retainers 2.

Referring to FIG. 2D is another end view of the Sure Grip Dual Head Shaving Razor showing you another direction of shave both shaving cartridges turn simultaneously, 45 degrees at a time or more making a full 360 degrees turn while fingers are attached to the ring retainers 2. Shaving stainless steel shaving blades 6, in the replaceable shaving cartridge 5, that is once again attached to the swiveling end 1, and the end view of the finger retainer base 4, showing where the index and middle fingers would fit comfortably due to different sizes, girls fingers would be slightly smaller retaining holes 2. The softer thermal plastic elastomer is plyable enough that the finger retainers hole size would not be much different than mens fingers.

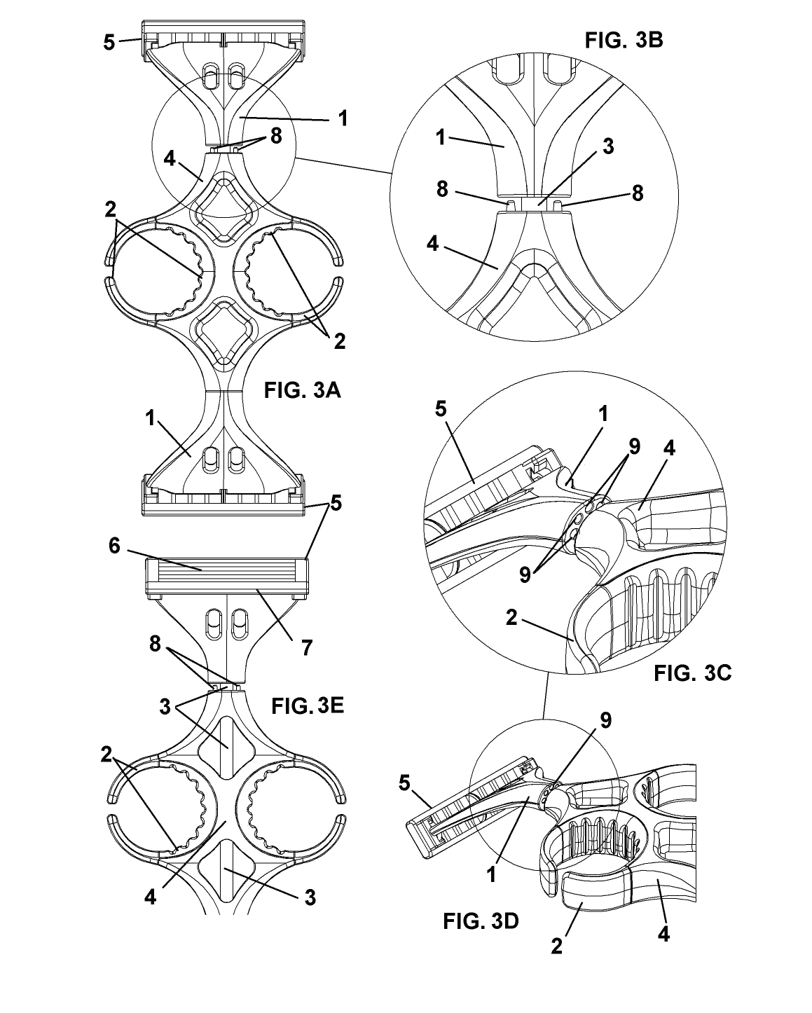

Referring now to page three of six, FIG. 3A is once again the top view of the two finger index and middle finger rings retainer base 4, is one with the top view of the finger partial rings retainer holes 2 for the index finger and the middle fingers, when retained will shave the hair off of the skin in a pulling motion one way with one end shaving cartridge 5, and shave in a pulling motion the opposite way with the opposite shaving cartridge 5 bi-directionally, up and down, and side to side. The finger partial rings 2 retainer base 4 is connected to the swiveling ends 1, which is attached to the back view of the replaceable shaving cartridges 5 at each end, this view shows the way both swivel end 1 turn 360 degrees, eight positions of shave at a time by simply pulling slightly up on the one swivel end 1 and the replaceable shaving cartridge 5 out of its locking mechanism 8.

Referring now FIG. 3B is the circled detailed view of the locking mechanism, the partial rings finger retainer base 4, and the rotating connecting rod 3 that is shown in FIG. 3E, connects the swiveling ends 1, when pulled the swiveling end 1 slightly up and out of its locking position holes 8, enabling both swiveling ends 1, and replaceable shaving cartridges 5 on opposite ends to turn freely, simply let go of the swiveling end 1 locking into 1 of 8 positions of shave.

Referring now to FIG. 3D shows half of the finger partial rings 2 retainer base 4, with the view of the thickness and depth of the partial rings 2 retainer 4, and the swiveling end 1, and the replaceable shaving cartridge 5 pulled out of its locking position showing the locking mechanism holes 9.

Referring now to the blown up view of FIG. 3C the finger partial rings 2 retainer base 4 and the swiveling end 1 and the replaceable shaving cartridge 5 pulled slightly out of the locking position enabling the two ends to turn freely simultaneously to the position of shave.

Referring to FIG. 3E illustrates the bottom view of the finger partial rings 2 retainer base 4, view of the locking mechanism knobs 8. The bottom side of the swiveling end 1 with the view of the stainless steel shaving blades 6, and the front of the shaving cartridge 5, most important the rotating connecting rod 3, that connects both swiveling ends 1 and shaving cartridges 5 allowing the ends to turn simultaneously as the fingers are retained.

Moving on to page four of six, FIG. 4A is the bottom of the finger partial rings 2 retainer base 4, with the bottom side of the finger partial rings 2, and the bottom of the swiveling ends 1 with the replaceable shaving cartridges 5, in the front position showing the stainless steel shaving blades 6, with the view of the rotating connecting rod 3 that when the one swiveling end 1 is disengaged allowing both shaving cartridges 5 and the swiveling ends 1 to freely turn simultaneously 360 degrees to the position of shave.

Referring now FIG. 4B to the cut away side view of the Sure Grip Dual Head Shaving Razor has the arc view at both ends from the finger partial rings 2 retainer base 4 to the shaving cartridges 5 showing the rotating connecting rod 3 connecting the two swiveling ends 1, that the replaceable shaving cartridges 5, with the stainless steel shaving blades 6, and the one swiveling end 1 pulled out of its locking connection mechanism 9 and the finger partial rings retainer base 4, connection mechanism 8.

Referring to FIG. 4C is the one end view of the stainless steel blades 6, which is part of the shaving cartridge 5 that is facing the upward position, which is attached to the swiveling end 1, that is connected to the rotating connecting rod 3, that passes through the middle of the index finger and the middle finger partial rings 2 retainer base 4, with a view of the thickness, and width of the two finger partial rings 2 retainer base 4 to the shaving cartridge showing the slight one end arc.

Referring now FIG. 4D is the circled blown up detailed view of the cut away FIG. 4B detent locking and unlocking mechanism by simply pulling up slightly on the one end rotating swiveling end 1 which the locking holes 9 are part of, out of the locking knobs 8, that are part of the finger partial rings 2 retainer base 4 enabling the rotating connecting rod 3 and the rotating swiveling ends 1 on both sides of the finger retainer base 4 to turn 360 degrees to the next position of shave.

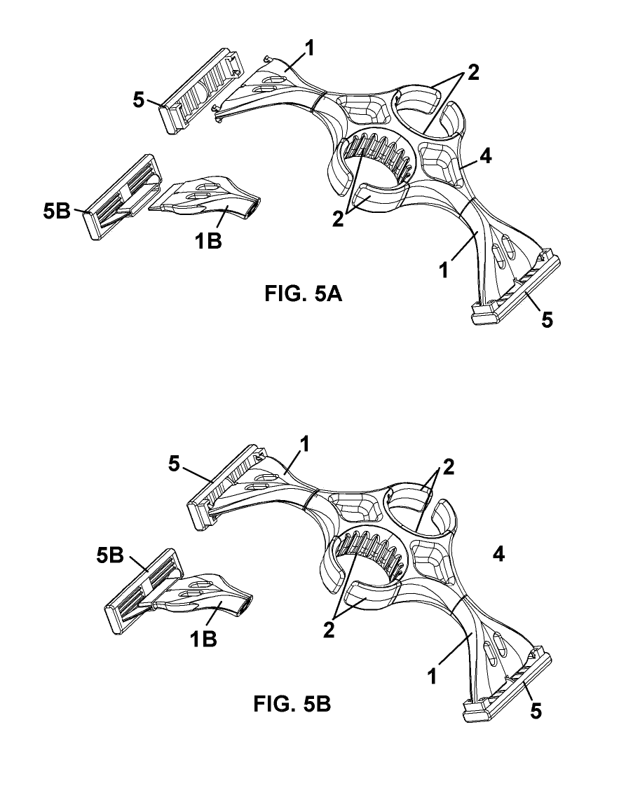

Referring now to once five of FIG. 5A is the view of the two finger partial rings 2 retainer base 4 with the partial rings 2 for retaining the middle finger and the index finger, with the rotating swiveling ends 1 at each end with the view of the replaceable shaving cartridges 5 disconnected, showing the latch, catch system, also 1B is view of the alternative rotating swiveling end 1B to another replaceable shaving cartridge 5B in the disconnected position.

Referring now to FIG. 5B is another view of the top of the two finger partial rings 2 retainer base 4 showing the thickness of the retainers base 4 for the index finger and the middle finger to fit comfortably in between the first knuckle and the second knuckle, with the original rotating swiveling end 1, attached to the replaceable shaving cartridges 5. Next is the alternative rotating swiveling end 1B and an alternate replaceable shaving cartridge 5B in the connected position. The catch latch system, and the alternate connection, is known in the field of art and a detailed description of its construction is not needed.

Those that have expertise in this technical scope of my invention will appreciate other ways of these two parts connecting together.

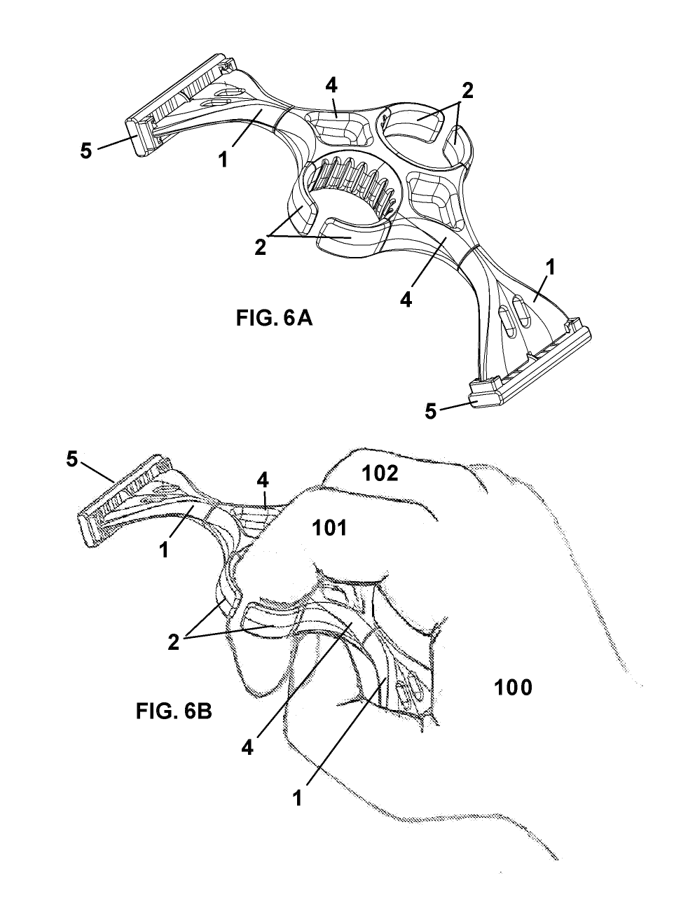

Referring to page six of six, another view FIG. 6A is a top view of the shaving apparatus Sure Grip Dual Head Shaving Razor, showing the two finger partial rings 2 retainer base 4 showing the sides of the partial rings 2 that are not connected making it easy for the fingers to fit in the retaining holes 2, with the rotating swiveling ends 1 at either end not showing the rotating connecting rod that passes through the middle of the base connecting to the rotating swiveling ends 1 waking it possible for both swiveling ends 1 and the replaceable shaving cartridges 5 to turn simultaneously 360 degrees and locking into 8 positions of shave.

Referring to FIG. 6B is a view of the shaving razor, the two finger partial rings 2 retainer base 4 with the view of the partial finger retainers, with rotating swiveling ends 1 at each end and showing the one end replaceable shaving cartridge 5 with the view of the hand 100 and the index 101 and middle 102 fingers engaged in the partial rings 2 showing how the fingers are comfortably retained to the Sure Grip Dual Head Shaving Razor making it so the shaving razor will never fall to the ground. Once again those who have experience in the technical scope of our invention will appreciate other ways of these two parts the replaceable shaving cartridge and the rotating swiveling end connecting together.

### DETAILED DESCRIPTION OF THE INVENTION

A preferred embodiment, dual replaceable shaving cartridges attached to rotating swiveling ends, with the opposite end of the rotating swiveling ends connected to a rotating connecting rod which passes through a finger partial rings retainer base, tubular in shape for the index and middle fingers to fit comfortably to the middle of the first knuckle and the second knuckle perpendicular to the rotating connecting rod. The finger partial rings retainer base is located in the middle of the rotating connecting rod, when the fingers are applied and retained making it impossible for the shaving apparatus to fall to the ground. Used for the medically needy, such as arthritis, shaking of the limbs, and hands. At the opposite ends of the rotating connecting rod, are the swiveling ends that the replaceable shaving cartridges are attached, which has an arc facing the same direction at both ends approx. 45 degrees, from the finger retainer base to the shaving cartridges the contour of the body. This novel shaving handle, while the fingers are retained to the finger retainer base has the ability for the rotating connecting rod which is connected to the swiveling ends that the replaceable shaving cartridges are attached to rotate simultaneously 360 degrees, 8 locking positions of shave, by simply pulling slightly the one locking side rotating swiveling end and shaving cartridge away, from the rotating connecting rod, and out of the locking position, which then allows both shaving cartridges and the swiveling ends, at each side of the rotating connecting rod to turn simultaneously 360 degrees to 1 of 8 position of shave and, then releasing back to the locking position while fingers are still retained to the finger retainer. The replaceable shaving cartridges with at least one stainless steel shaving blade will be attached to the one end of the rotating swiveling ends, and at the other end of the rotating swiveling ends, the rotating connecting rod is connected, allowing the rotating connecting rod, the swiveling ends, and the replaceable shaving cartridges, to turn simultaneously. While the index finger and the middle finger d re retained to the finger partial rings retainer base, both replaceable shaving cartridges will be attached to the rotating swiveling ends, parallel to the area being shaven, with the stainless steel blades facing the middle, inward toward the finger retainer base, and the stainless steel blades shaving cartridges connected to touch the area being shaven simultaneously making it possible when the fingers are retained to shave in a pulling motion one way, and pulling motion the opposite direction, bi-directionally. There are marry way to attach replaceable shaving cartridges. Those that have experience in this technical scope of my invention will appreciate numerous ways of these two parts connecting together.

What we claim as our invention is:

1. Shaving razor comprising:
a cutting means;
a dual finger partial rings retainer base for retaining comfortably the index and middle fingers; and,
a rotating connecting rod that passes through the center of the index and middle finger partial rings retainer base with rotating swiveling ends connected to the both ends; and,
a cutting means is a first replaceable shaving cartridge attached to the one side of the rotating swiveling end, with at least on stainless steel shaving blade; and,
a second replaceable shaving cartridge attached to the other side swiveling end, with at least one or more stainless steel razor blade.

2. A shaving razor comprising:
an approx. 45 degree arc the shape of the head, from the finger retainer base to the replaceable shaving cartridges, attached at the ends of the rotating swiveling end; and,
Whereas connected to the opposite ends of the rotating connecting rod are the swiveling ends where the replaceable shaving cartridges are attached will be able to turn simultaneously 360 degrees, 8 positions of shave; and,
Whereas the index and middle fingers are retained in the finger rings retainer base, perpendicular to the connecting rod.

3. A shaving razor comprising:
an 8 position of shave locking mechanism by slightly pulling the one side of the rotating swiveling end and the shaving cartridge out of its locking position, enabling both shaving cartridges, and the rotating swiveling ends, each to turn simultaneously, locking into 1 of 8 position of shave and releasing allowing the one side to return to the locking position. An 8 position of shave locking mechanism, the swiveling end that when disengaged, unlocking will be able to see the 8 holes where the swiveling end and the two finger rings retainer base end come together; and,
whereas the two finger partial rings retainer base that has the 8 knobs that are observed when disengaged and able to turn 360 degrees in diameter; and,
whereas when the two parts are pulled apart slightly, allowing the 360 degree rotation to the 8 positions of shave.

4. The shaving razor of claim 2, whereas the rotating swiveling end is attached perpendicular to the ends of the rotating connecting rod.

5. The shaving razor of claim 2, whereas the stainless steel blades of the shaving cartridge will be facing the middle of the elongated rod where the two finger partial rings retainer base is.

6. The shaving razor of claim 1, whereas, both replaceable stainless steel blades shaving cartridge will be attached perpendicular to the ends of the rotating swiveling ends, and facing toward the middle of the base.

7. The shaving razor of claim 1, a bore axis which is coextensive with the finger diameter to the finger partial rings retainer base located in the middle of the elongated rod.

8. The shaving razor of claim 1, whereas partial ring means the rings are not total rings but a separation at the sides of the flexible ring base so when applying fingers in the finger base they will fit comfortably by the flexible rings opening to fit the diameter of the fingers.

9. The shaving razor of claim 1, the retainer base member handle, and the rotating swiveling end will be made of more rigid stiff part will most likely be a polystyrene (PS), and, or a light weight metal.

10. The shaving razor of claim 2, the two finger partial rings the softer grip areas will be a thermal plastic elastomer (TPE), of the sort.
